(19) United States
(12) Patent Application Publication
(10) Pub. No.: US 2015/0149842 A1
(43) Pub. Date: May 28, 2015

(54) TEST DEVICE AND METHOD USING A SEPARATE CONTROL MODULE FOR TEST

(71) Applicants: INVENTEC (PUDONG) TECHNOLOGY CORPORATION, Shanghai (CN); INVENTEC CORPORATION, Taipei (TW)

(72) Inventors: Zhe-Zhang YUAN, Shanghai (CN); Hui YUN, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 14/244,449

(22) Filed: Apr. 3, 2014

(30) Foreign Application Priority Data
Nov. 28, 2013 (CN) 201310625515.6

(51) Int. Cl. G06F 11/22

(52) U.S. Cl. CPC G06F 11/2273
USPC 714/724

(57) ABSTRACT

A test device and method using a separate control module for test are disclosed, where a main console is replaced with a control module of the test device, the control module may generate a control command after receiving the a command transmitted from the main console, and transmit the control command to at least one PLD corresponding thereto, the PLD may control the GIPO comprised thereby to test the unit under test according to the received control command, whereby reducing the test time and achieving in the effect where the main console may do the other work concurrently when engaging in the test for the unit under test.

### BACKGROUND OF THE RELATED ART

1. Technical Field

The present invention relates to a test device and method, and particularly to a test device and method using a separate control module for test.

2. Related Art

In the course of testing an electronic product, it is typically to test I/O pins of the electronic product.

Presently, a particular test device is used for test. In each test, an expected result for an object test is set on the test device by a main console. Then, the main console controls the test device to test the I/O pins of the electronic product (unit under test) for their contact for the particular test until all the test subjects are finished.

However, this fashion may let the main console be totally engaged, resulting in that the main console can only process on the current test job. Thus, the above method may be suitable to the devices having a few I/O pins for their contact test. Once the IO/pins of the electronic device are large, the engaged time of the main console may increase, lending to an increased test time correspondingly.

In addition, in the above method, every test needs the expected result to be set on the test device. However, the setting for the expected result may be slow in speed, and thus the test time may increase as the I/O pins and thus the test subjects increase.

In view of the above, it may be known that there is long the issue where the large amount of I/O pins causes the test time to be long for the electronic product. Correspondingly, there is quite a need to set for a technical means to solve this problem.

### SUMMARY

In view of the issue where the large amount of I/O pins causes the test time to be long for the electronic product, the present invention discloses a test device and method for using a separate control module for test.

According to the present invention, the test device for using a separate control module for test, connected to a main console and a unit under test, comprises a control module, receiving a test command transmitted from the main console, generating at least a control command according to the test command, and transmitting the control command in order; and at least a programmable logic device (PLD), each comprising a plurality of general purpose I/O (GPIO) ports for controlling at least one of the GPIO ports according to the control command transmitted from the control module, whereby testing the unit under test.

According to the present invention, the test method for using a separate control module for test, comprises steps of transmitting a test command to a test device by a main console, the test device comprising a control module and at least a programmable logic device (PLD); generating at least a control command according to the test command corresponding thereto by the control module, and transmitting the control command to the PLD corresponding thereto in order; and controlling at least one of the plurality of GPIO ports comprised thereby according to the received control command by the PLD to test a unit under test.

The device and method of the present invention has the difference as compared to the prior art that the present invention replaces the main console with the control module of the test device, the control module may generate the corresponding control command after receiving the test command transmitted from the main console, and transmit the control command to the PLD corresponding thereto, the PLD receiving the control command may control the GIPO comprised thereby to test the unit under test according to the control command, whereby solving the issue existing in the prior art and achieving in the efficacy where the main console may do the other work concurrently when engaging in the test for the unit under test.

### BRIEF DESCRIPTION OF THE DRAWINGS

The present invention will be apparent from the following detailed description, which proceeds with reference to the accompanying drawings, wherein the same references relate to the same elements.

FIG. 1 is a schematic diagram of an element tested by using a separate control module according to the present invention;

FIG. 2 is a schematic diagram of a programmable logic element (PLD) according to the present invention; and

FIG. 3 is a flowchart of a test method by using the separate control module according to the present invention.

### DETAILED DESCRIPTION

The present invention will be apparent from the following detailed description, which proceeds with reference to the accompanying drawings, wherein the same references relate to the same elements.

The present invention provides a test device using a separately operating control module. When the test device receives a test command from a main console, the control module may execute a test process corresponding to the received test command, and control at least one general purpose I/O (GIPO) port comprised by the test device to test a unit under test according the test process.

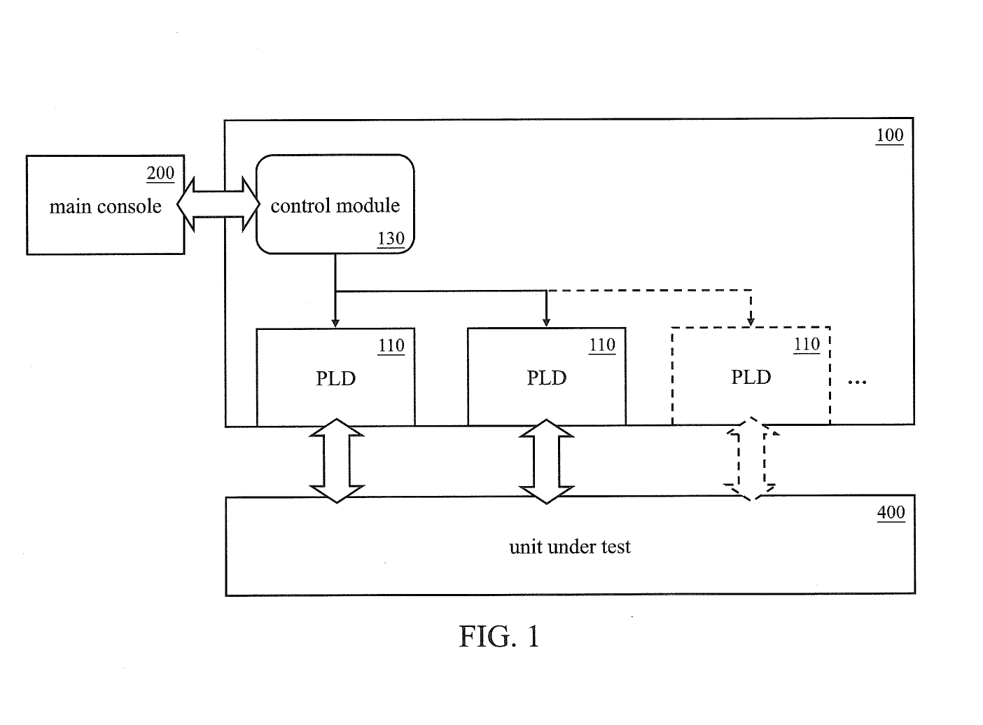

Thereafter, FIG. 1 is illustrated to explain how the test device of the present invention using the separate control module is operated, in which a schematic diagram of an element tested by using a separate control module according to the present invention is shown. The test device 100 of the present invention comprises a programmable logic device (PLD) 110 and a control module 130.

The PLD 110 comprises a plurality of GIPO ports, receives a control command from the control module 130, and controls one or more of the GIPO ports according to the received control command. Generally, the PLD 110 may control one or more GIPO ports to output a test signal to corresponding pins on the unit under test 400 according to the received control command. The PLD 110 may also control one or more GIPO ports to receive a response signal from the corresponding I/O pins on the unit under test 400 according to the received control command.

It is to be particularly pointed out that since the PLD 110 comprises a large amount of GIPO ports, it is particularly used in the case where the unit under test 400 has a large amount of I/O pins and the signal on each of the I/O pins is required to be tested. At the same time, since the signal switched time of the GIPO ports are very short, the case is also very suitable to be applied with the PLD 110 for testing the unit under test having its pins having rapid changes on their signals.

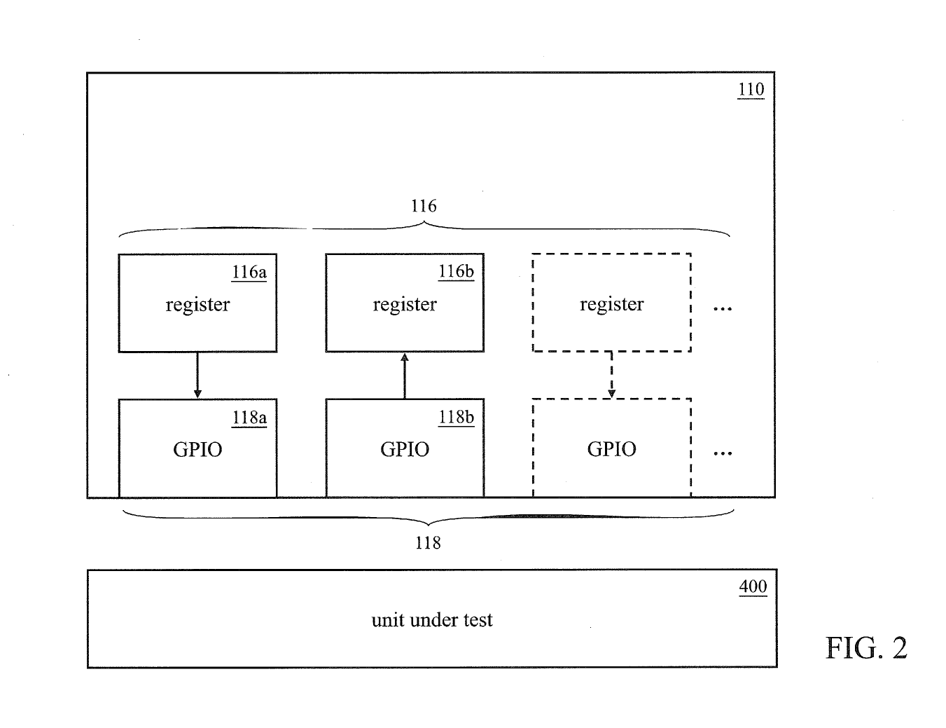

In addition, the PLD 110 may also comprise a register 116, as shown in FIG. 2. The register 116 may provide the PLD 110 to control the GIPO ports 118 to output a test signal to the unit under test 400. For example, the PLD 110 may set the register 116a to be logic high/low. At this time, the GIPO 118a connected to the register 116a may output a test signal presenting logic high/low to the corresponding input pin of the unit under test 400.

The PLD 110 may also acquire a response signal on the I/O pin corresponding to the GIPO port 118 on the unit under test 400 through the register 116. For example, after the GIPO port 118b acquires the response signal on the particular I/O pin of the unit under test 400, the register 116b may be set as logic high/low by the potential of the response signal. At this time, the PLD 110 may acquire the potential of the response signal by the potential of the register 116b.

The control module 130 is used to receive a test command from the main console 200. The main console 200 may transmit different test commands to the test device 100 according to different test requirements, such as a test for different unit under tests or a test for different portions of the same unit under test, so that the control module 130 may perform different test process flows according to the different test commands.

The control module 130 also generates the control command corresponding to the test command received. The control command corresponding to the test command generated by the control module 130 may be only one, or may be more than one, without limiting the present invention. Since the test flow conducted by the control module 130 may be different as the received test command varies, the control command generated by the control module 130 for testing may also differ as the test command varies.

The control module 130 transmits the generated control command to the one or more PLDs 110 corresponding to the control command in order. The control module 130 may transmit the control command to the corresponding PLD 110 according to the test flow, so that a portion or the whole of the PLDs 110 on the test device 100 executes the control command by a particular subsequence, whereby testing the connectivity of the I/O pins of the unit under test 400.

It is to be particularly noted that the main console is continuously occupied in the course of testing in the prior art, until the test is finished. However, in the present invention, the control module 130 replaces the purpose of the main console in the prior art. That is, the main console 200 needs only to transmit the test command to the control module 130 at the beginning of the test on the unit under test 400, and the control module 130 is instead used for the complete test flow. At the same time, the main console 200 may, when the control module 130 is in charge of the test flow, perform other functions, such as a test on other test subjects. As such, as far as the main console 200 is concerned, it is testing the I/O pins of the unit under test and other test subjects at the same time, by which the test time is significantly reduced. However, when the control module 130 is engaged in the testing job, the function which may be performed by the main console 200 is not limited to the above example.

In some embodiments, the control module 130 may read the response signal acquired by each of the PLDs 110 on the test device 100, and compare the response signal read from each of the PLDs 110 with the expected data corresponding to the control command received. Furthermore, the control module 130 may first convert the read response signal from analog into a digital, and then compare the digital response signal with the expected data, without limiting the present invention. Then, a test result corresponding to the response signal is generated after the comparison, when the comparison shows the response signal for each of the PLDs 110 and the expected data all meets up with each other, or one or several response signals for all the PLDs 110 do not meet up with the expected data.

However, the test result mentioned in the present invention is not limited to the example, any data capable of pointing out that the response signal is totally identical with the expected data or not may be served as the test data mentioned in the present invention. Furthermore, the expected data of the control module 130 compared to the response signal may be comprised in the received control command, and may also be pre-stored in the test device 100. After receiving the control command, the control module 130 may read the corresponding expected data according to the control command.

The control module 130 may also transmits the generated test result to the main console 200 after receiving the collection instruction from the main console 200. Furthermore, the control module 130 may transmit a notification signal to the main console 200 by its own after the test finished, i.e. after reading all the response signal to be compared, so that the main console 200 transmits the collection instruction to the control module 130. The control module 130 may also wait for a polling from the main console 200 in a passive manner. That is, the control module 130 waits for a polling message transmitted from the main console 200, and transmits a confirm message to the main console 200 after receiving the polling message, so that the main console 200 transmits the collection instruction to the control module 130.

In addition, to avoid a lack of the GPIO ports of the test device 100 in testing the I/O ports of the unit under test 400 at one time, the control module 130 and the PLDs 110 are connected through a serial peripheral interface (SPI). Since the serial peripheral interface may readily let the control module 130 connect multiple PLDs 110, the number of the I/O ports of the unit under test 400 tested by the test device 100 may be readily extended. At the same time, since the data transmission speed (16M) of the serial peripheral interface is larger than the data transmission speed (100K) in the associated prior art, the control module 130 may acquire all the response signals in a rather short time when testing a unit under test 400 having a large amount of I/O pins. However, the connection manner between the control module 130 and the PLDs 110 is not only limited by the serial peripheral interface.

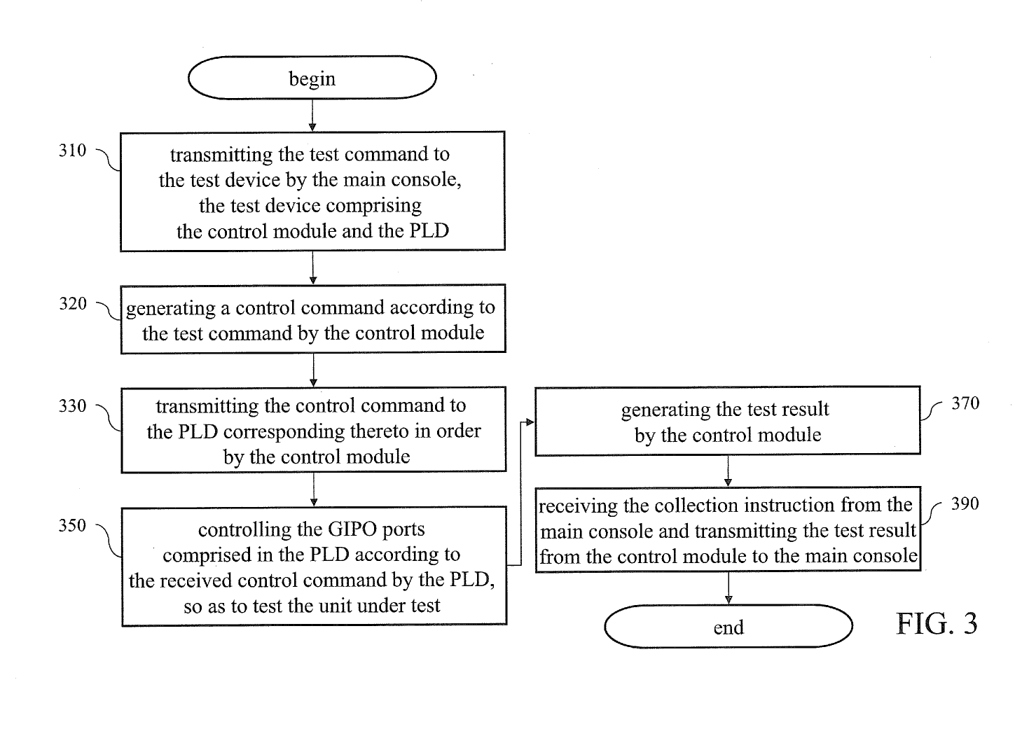

Thereafter, an embodiment is set forth to explain how the system and method of the present invention is operated, with simultaneously reference to FIG. 3, in which a flowchart of the test method busing a separate control module according to the present invention is illustrated. In this embodiment, assume the control module 130 is a micro-control unit (MCU) and the PLD 110 is a complex programmable logic device (CPLD), but which are merely examples, without limiting the present invention.

At first, the main console 200 may transmit the test command to the test device 100 (S310). Next, the main console 200 may perform other test subjects. In this embodiments, assume the main console 200 is connected to the test device 100 through an inter-integrated circuit, then the test command may be comprised in the data section of a packet in the inter-integrated circuit.

The control module 130 of the test device 100 may de-capsulate the packet of the inter-integrated circuit after receiving the packet transmitted from the main console 200, and obtain the test command comprised in the packet, so as to generate a control command corresponding to the obtained test command (S320). In this embodiment, assume the control module 130 may determine a test flow according to the test command, and generate a control command which may finish the determined test flow according to the determined test flow.

After the control module 130 of the test device 100 generates the control command, the control module 130 may transmit the generated control command in order to the PLD 110 corresponding to the generated control command (S330). In this embodiment, assume the control module 130 and the PLD 110 are connected to each other through the serial peripheral interface. The control module 130 may use a serial peripheral interface protocol to transmit the generated control command to the corresponded PLD 110.

After the PLD 110 of the test device 100 receives the control command transmitted from the control module 130 of the test device 100, the PLD 110 may control the comprised GIPO ports 118 according to the received control command, so as to test the unit under test 400 (S350). As such, the main console 200 may finish the test on the unit under test 400 through the control module 130 of the test device 100 which may conduct separately the test task, and will not be occupied when the unit under test 400 is tested.

In this embodiment, assume the control module 130 generates three sets of control command. Among them, the first set of control command enables the PLD 110 receiving the control command to control the comprised GIPO port 118 to output the test signal to the I/O pin of the unit under test 400 corresponding to the test signal, and the other GIPO ports 118 may acquire the response signal on all the I/O pins of the unit under test 400. The second set of control command may enable the PLD 110 received the control command to control the multiple particular GIPO ports 118 comprised to output the test signal, and all the other GIPO ports 118 may similarly acquire the response signal on all the I/O pins of the unit under test 400. The third set of control command may enable the multiple PLDs receiving the control command to control one or more of the GIPO ports 118 to output the test signal. Similarly, all the other GIPO ports may acquire the response signal on all I/O pins of the unit under test 400.

Subsequently, the control module 130 of the test device 100 may use the serial peripheral interface protocol to transmit a reading instruction for reading data to all the PLDs 110. After receiving the reading instruction, the PLDs 110 may similarly use the serial peripheral interface protocol to transmit back the acquired response signal to the control module 130. After receiving the response signal from all the GIPO ports 118 of one of the PLDs 110, the control module 130 may compare the received response signal with the expected data corresponding to the generated control command, and generate a test result after the comparison (S370). In this embodiment, since the control module 130 generates three sets of control command, the control module 130 may also transmit one reading instruction after each time of the control command transmitted to each of the PLDs 110, and compare the response signal transmitted back from each of the PLDs 110 with the expected data corresponding to the control command transmitted. Furthermore, when all the response signals and the expected data are identical, the control module 130 may generate the test result representing no error. On the other hand, if anyone of the response signals is different from the expected data, the control module 130 may record an identification of the GIPO acquiring the response signal differing from the expected data, and even record the potential of the test signal and the response signal.

In addition, after the control module 130 of the test device 100 finishes the test of the unit under test 400, the control module 130 may receive the collection instruction transmitted from the main console 200 (S390), so that the main console 200 may provide the test result generated by the control module 130 to the tested for reference. In this embodiment, assume the main console 200 may make a periodical polling by using the inter-integrated circuit packet to determine if the test has been finished. When the control module 130 finishes the test, it may similarly use the inter-integrated circuit packet to transmit back a confirm signal to the main console 200, and the main console uses the inter-integrated circuit packet to transmit the collection instruction to the control module 130 as a response. As such, the control module 130 may use the inter-integrated circuit packet to transmit back the test result to the main console 200.

In view of the above, the device and method of the present invention has the difference as compared to the prior art that the present invention replaces the main console with a control module of the test device, the control module may generate the control command after receiving the test command transmitted from the main console, and transmit the control command to the PLD corresponding thereto, the PLD receiving the control command may control the GIPO ports comprised thereby to test the unit under test according to the received control command, whereby solving the issue existing in the prior art the issue where the large amount of I/O pins causes the test time to be long for the electronic product, and achieving in the efficacy where the main console may do the other work concurrently when engaging in the test for the unit under test.

Furthermore, the computer system and clicking signal processing method therefore according to the present invention may be implemented in a hardware, a software or a combination thereof. Alternatively, the method may also be implemented in a single unit or separate computer systems connected with one another with discrete components arranged therein.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A test device for using a separate control module for test, connected to a main console and a unit under test, comprising:
a control module, receiving a test command transmitted from the main console, generating at least a control command according to the test command, and transmitting the control command in order; and
at least a programmable logic device (PLD), each comprising a plurality of general purpose I/O (GPIO) ports for controlling at least one of the GPIO ports according to at least the control command transmitted from the control module, whereby testing the unit under test.

2. The test device as claimed in claim 1, wherein each of the PLDs further comprises a register for providing the PLD for controlling at least one of the GPIO ports.

3. The test device as claimed in claim 1, wherein the PLD controls at least one of the GPIO ports to output a test signal to the unit under test according to one of the received control commands.

4. The test device as claimed in claim 1, wherein the PLD control at least one of the GPIO ports to receive a response signal generated by the unit under test according to one of the received control commands.

5. The test device as claimed in claim 4, wherein the control module further reads the response signal and compares the response signal with an expected data corresponding to the received control command to generate a test result corresponding thereto.

6. The test device as claimed in claim 5, wherein the control command further transmits the test result to the main console after receiving a collection instruction from the main console.

7. The test device as claimed in claim 6, wherein the control module further outputs a notification signal to notify the main console to transmit the collection instruction.

8. A test method for using a separate control module for test, comprising steps of:
transmitting a test command to a test device by a main console, the test device comprising a control module and at least a programmable logic device (PLD);
generating at least a control command according to the test command corresponding thereto by the control module, and transmitting the control command to the PLD corresponding thereto in order; and
controlling at least one general purpose I/O (GIPO) ports comprised in the PLD according to the received control command by the PLD to test a unit under test.

9. The test method as claimed in claim 8, wherein the step of controlling the GIPO ports comprised in the PLD according to the received control command by the PLD comprises a step of controlling at least the GIPO port to output a test signal to the unit under test by the PLD.

10. The test method as claimed in claim 8, wherein the step of controlling the GIPO ports comprised in the PLD according to the received control command by the PLD comprises a step of controlling at least the GIPO ports to receive a response signal generated by the unit under test.

11. The test method as claimed in claim 10, wherein further comprises a step of reading the response signal and comparing the response signal with an expected data corresponding to the received control command to generate a test result corresponding thereto after the step of controlling the GIPO ports comprised in the PLD according to the received control command by the PLD.

12. The test method as claimed in claim 11, further comprising a step of transmitting the test result to the main console after the step of receiving a collection instruction from the main console by the control module.

13. The test method as claimed in claim 12, further comprising a step of transmitting a notification signal to the main console by the control module for notifying the main console to transmit the collection instruction.
